(19) United States
(12) Patent Application Publication
(10) Pub. No.: US 2009/0029682 A1
(43) Pub. Date: Jan. 29, 2009

(54) MESSAGE GENERATION FOR MOBILE COMMUNICATION DEVICES

(75) Inventors: Newton Meyer Fleury Filho, Rio de Janeiro (BR); Danilo Medeiros, Rio de Janeiro (BR); Bruno Goyanna, Rio de Jameiro (BR); Paulo Lima, Rio de Janeiro (BR)

Correspondence Address: FISH & RICHARDSON PC, P.O. BOX 1022, MINNEAPOLIS, MN, 55440-1022, US

(73) Assignee: Blah! Sociedade Anonima de Servicos e Comercio

(21) Appl. No.: 12/196,582

(22) Filed: Aug. 22, 2008

Related U.S. Application Data
(63) Continuation of application No. 10/921,483, filed on Aug. 18, 2004, now abandoned.

(51) Int. Cl. H04W 88/00

(52) U.S. Cl. 455/412.2

(57) ABSTRACT

Methods and apparatus, including computer program products, for receiving, at a first computing system, a notification of a triggering event, generating a short message based on the notification, the generated short message including advertisement content, and sending the generated short message to a mobile communications device.

### CROSS-REFERENCE TO RELATED APPLICATION

This application is a continuation of U.S. application Ser. No. 10/921,483, filed Aug. 18, 2004.

### BACKGROUND

This description relates to mobile communication.

GSM (Global System for Mobile Communication) equipment manufacturers and carriers adhere to a set of international standards, which cover aspects of mobile communication from the physical size and characteristics of certain devices to the way they handle and store incoming information.

GSM-based mobile telephones support both digitized voice communications as well as data communications between mobile telephones and the fixed communication infrastructure. Data communication is supported by a Short Message Service (SMS), and in certain areas additionally by connection-based services such as General Packet Radio Service (GPRS). SMS provides a way of sending short messages from mobile telephones or computers to mobile telephones and receiving short messages from mobile telephones. A message received at a mobile telephone can consist of text characters to read by a person, or data to be handled by a computer program executing in the mobile telephone.

GSM telephones include a removable electronic module, a Subscriber Identity Module (SIM), that includes information related to a subscriber. The GSM standards define the physical, electrical, and software interfaces for SIM modules. A SIM provides a secure, tamper-resistant environment for the cryptographic keys that GSM carriers use to authenticate individual subscribers to the network connection and track those subscriber's activities once they are on the air. The SIM maintains a constant connection to the network as long as the mobile device remains on. This location-aware, authenticated connection is what allows subscribers to roam from network to network around the world. Although SIMs are generally associated with GSM phones, SIMs or functionally similar modules can also be found in some CDMA phones, iDen phones, and TDMA phones.

GSM SIMs can also include a processor and memory that allow hosting of software applications on the SIM. The SIM Application Toolkit (SAT) standardizes the way in which such applications can be developed for and loaded onto the SIM by SIM application developers. The SAT API (application program interface) provides for two types of information flow between a SIM Toolkit application and the user device or the network, namely proactive commands and event downloads. An event download is a message from the user device to a SIM Toolkit application notifying it of an event, such as an incoming voice call or SMS message. A proactive command is a command from a SIM Toolkit application to the user device asking it to do something on its behalf. As of the GSM standards in September 2003, there are 31 proactive commands on the SAT API as listed in ETSI TS 102.223. These 31 proactive commands can be divided into four categories: (1) application commands that SIM Toolkit applications use to interact with a user of the device (e.g., Display Text, Get Input, Setup Menu); (2) smart-card commands that the SIM uses to interact with another smart card plugged into the user device (e.g., Power On Card, Launch Browser); (3) general communication commands that the SIM uses to interface with various bearers (e.g., GSM, GPRS) that the user device supports (e.g., Get Data, Receive Data, Open Channel); and (4) system commands that the SIM uses to stay synchronized with the user device and the network (e.g., Poll Interval, Language Notification).

One type of application that has been developed for mobile telephones has been a “microbrowser” application that enables a mobile user to access remote content in a manner similar to computer users accessing Web pages. SIM-hosted microbrowsers have been developed to operate in a manner very similar to a Web browser. For example, a microbrowser communicates with a network component called Wireless Internet Gateway (WIG), which can access Internet-based servers, over a data channel such as using SMS or GPRS messages. The WIG enables the usage of an easy to use application language (e.g., Wireless Markup Language (WML)). WML applications are stored on a content provider's server on the network. When a user selects an item in a service menu displayed on the user device, the microbrowser sends a SMS message including a Uniform Resource Locator (URL) to the WIG. The WIG uses HyperText Transfer Protocol (HTTP) to retrieve WML data associated with the URL, translates the WML content into bytecodes, and sends the bytecodes back to the microbrowser in an SMS message. The microbrowser executes the byte-coded program and renders one or more menus on the display of the user device.

### SUMMARY

The techniques in this specification provide methods and apparatus, including computer program products, for supporting the transmission of short messages between mobile communication devices and computing systems.

The computer program product at a first computing system includes techniques for receiving a notification of a triggering event, generating a short message based on the notification, the generated short message including advertisement content, and sending the generated short message to a mobile communications device.

The triggering event can include an initiation of a short message transaction by the mobile communications device. The initiation of the short message transaction can include a transmission of a short message from the mobile communications device to a second computing system. The triggering event can include a web-based triggering event, such as a subscription event at a web site associated with the second computing system. The first computing system and the second computing system can be hosted on the same server or on different servers.

The notification can include information characterizing one or more of a user information, a mobile communications device information, and a triggering event.

To generate the short message, the computer program product at the first computing system can include techniques for using the information in the notification to identify one or more categories of advertisement content, selecting advertisement content from among the identified categories, and encoding the selected advertisement content using one of a plurality of protocols to generate one or more advertisement display generation commands. The techniques for using the information in the notification can include accessing user profile information associated with the user information included in the notification. The techniques for sending the generated short message to the mobile communications device can include sending each of the one or more advertisement display generation commands to the mobile communications device separately.

The computer program product at the second computing system includes techniques for receiving a short message from the mobile communications device. If the received short message includes a data request, the computer program product at the second computing system includes techniques for processing the data request to generate a short message, the generated short message including transaction-specific data, and sending the generated short message to the mobile communications device. The computer program product at the second computing system includes techniques for generating a notification upon receipt of the short message from the mobile communications device, and sending the notification to the first computing system.

The computer program product at the mobile communications device includes techniques for receiving the generated short message from the second computing system, generating a transaction-specific display based on the received transaction-specific data, and rendering the transaction-specific display on a screen. The computer program product at the mobile communications device includes techniques for receiving the generated short message from the first computing system, generating an advertisement display based on the received advertisement content, and rendering the advertisement display on a screen.

The advertisement display rendered on the screen of the mobile communications device can include a dynamic menu, a dynamic text display, and a dynamic text display requesting user input.

Advantages that can be seen in particular implementations of the invention include one or more of the following. The advertisement content is provided to and rendered on the screen of a user device when it is likely that a user is looking at the screen of the user device because he/she is expecting another message. A mobile network operator or vendor can specify a maximum number of times any given user is to receive a particular SMS message having advertisement content from the advertisement application. The mobile network operator or vendor can also specify a maximum number of SMS messages having advertisement content the advertisement application may send a user in a particular period of time. An SMS message including an invalid command or a particular sequence of SMS messages sent by a user may result in the advertisement application sending one or more SMS messages including a tutorial that teaches the user how to send, e.g., the correct commands to an application residing at an application server in order to get a desired result. One implementation includes all of the foregoing advantages. The details of one or more examples are set forth in the accompanying drawings and the description below. Further features, aspects, and advantages of the invention will become apparent from the description, the drawings, and the claims.

### DESCRIPTION OF DRAWINGS

FIG. 1 shows a communication system.

FIG. 2 shows a timing diagram.

FIG. 3 shows advertisement content rendered on a screen of a user device.

Like reference numbers and designations in the various drawings indicate like elements.

### DETAILED DESCRIPTION

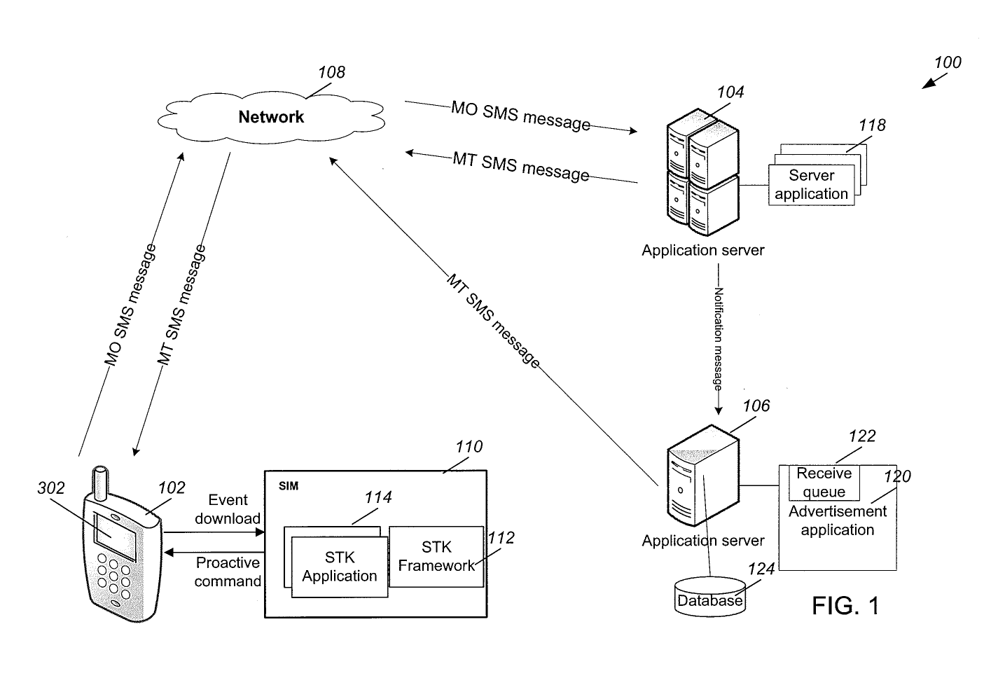

FIG. 1 shows a communications system 100 that supports communication between user devices 102 (e.g., mobile telephones) and other user devices (e.g., other telephones) and server computers (104 or 106). The system supports transmission of short messages between application servers 104, 106 and a user device 102 through a network 108. The term “SMS message” includes short messages encoded using the ETSI TS 123.040 SMS protocol. The application servers 104, 106 may be configured to send bytecode commands in one or more SMS messages to the user device 102, which uses the received bytecode commands to render a menu on a screen of the user device 102, or to perform other functions to provide information to or solicit information from a user of the device 102.

In one version of the system 100, a SMS message transmitted from the user device 102 to the application server 104 is a simple text message generated when a user inputs text using a keypad of the user device 102. In another version of the system 100, described in more detail below, a SMS message transmitted from the user device 102 to the application server 104 is generated by an application residing on the user device 102 in response to a user input at the user device 102. These descriptions of SMS messages are merely exemplary and are not to be construed in a limiting sense. Short messages encoded using protocols other than the SMS protocol may also be transmitted through the network 108.

In the description of the examples to follow, the user device 102 is a GSM phone having a SIM 110. In an alternative version of the system 100, the user device 102 may be a CDMA phone having a R-UIM, TDMA phone having a TIM, or the like. The illustrated communications system 100 may include additional or alternative user devices that are not shown, or the communications system 100 may include only a subset of the user devices that are shown.

The SIM 110 has memory (for data and applications), a processor and the ability to interact with the user. Current SIMs typically have 16 to 64 kb of memory, which can be used to store a SIM Toolkit framework 112, one or more SIM Toolkit application code and their associated data 114, as well as the secret keys and certificates used for digital signatures and other encryption and authentication functions (not shown). The SIM Toolkit (STK) framework 112 is the GSM Java Card runtime environment (i.e., a Java virtual machine, which includes an interpreter and a defined set of resident class libraries) that is defined by ETSI TS 101.476 V8.5.0 (2002-09). The STK applications 114 may be implemented as text-based, menu-driven, single-key response STK applications 114. The term “text-based, menu-driven, single-key response STK application” generally refers to an application that provides a user interface in which a user can highlight a command or option from the menu provided on a screen of the user device 102 and then press a single key to select the command or option.

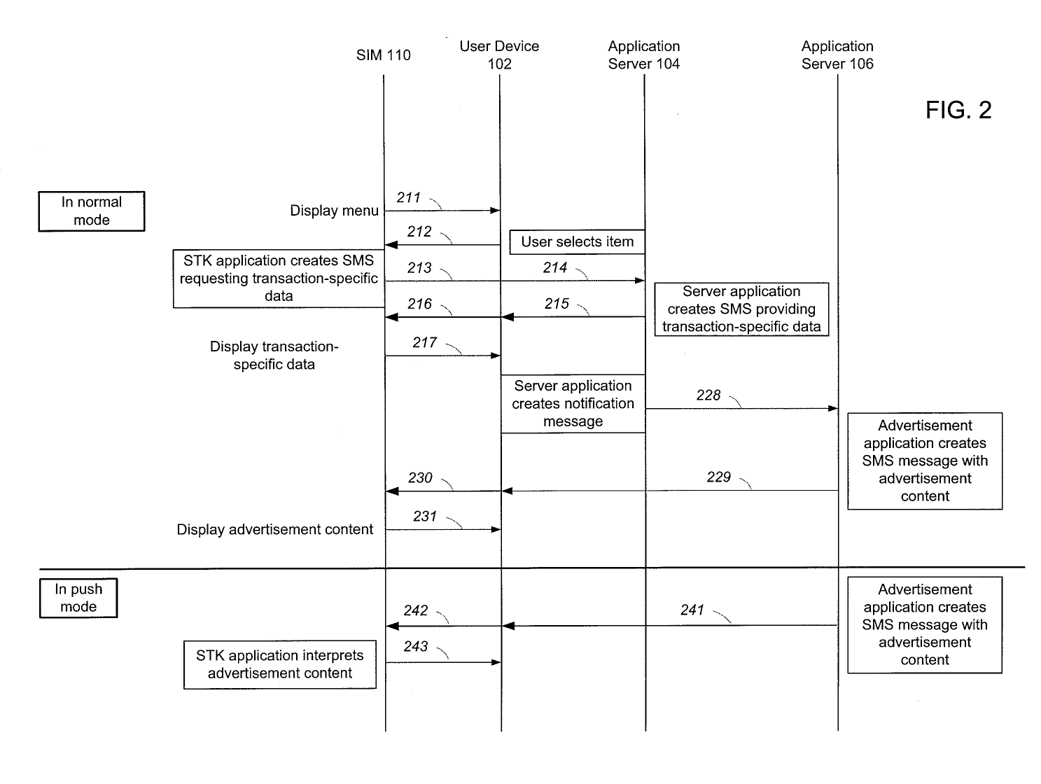

An example of a STK application 114 is a chat application stored in the SIM 110. Referring to FIG. 2, when the STK application 114 is initiated, it sends a STK “Select Item” proactive command 211 which causes the user device 102 to render a menu of chat feature items (e.g., “Send instant message” and “Are my friends online?” on the screen of the user device 102. When the user selects the “Are my friends online?” chat feature item, for example, the user device 102 sends a STK “User Activity Event” event download 212 to the STK application 114 and the STK application 114 executes an action associated with the user-selected item. The STK application 114 sends a proactive command 213 which causes the user device 102 to send an SMS message 214 to a server application 118 including a data request.

The server application 118 uses data provided in the payload of the SMS message 224 to generate a SMS message 215 having transaction-specific data. In one example, the server application 118 uses International Mobile Subscriber Identifier (IMSI) data provided in the payload of the SMS message 214 to retrieve a user profile (described in more detail below) stored in a database 124 accessible by the server application 120. The server application 118 uses the user profile to retrieve a “friend” list that identifies nicknames of family members, co-workers and friends (collectively “friends”) that the user has previously-added to his/her “friend” list. The sever application 118 determines which of the user's friends are currently online, and returns in the payload of the SMS message 215 a list of one or more nicknames. The user device 102 receives the SMS message 215 and passes the transaction-specific data to the STK application 114 using an event download 216. The STK application 114 sends a proactive command 217 which causes the user device 102 to display the transaction-specific data to the user on the screen of the user device 102.

In addition to generating the SMS message 215 having transaction-specific data, application logic resident at the server application 118 creates a notification message 228 that is sent to the application server 106 upon receipt of the SMS message 224. Generally, each notification message 228 includes a header and a payload. The header uniquely identifies a server application (“advertisement application” 120) on the application server 106 for processing the notification message 228. The payload includes information about a short message transaction between the user device 104 and the application server 104. Examples of information about a short message transaction include information identifying the user device 102 (e.g., an International Mobile Equipment Identifier (IMEI)), the user (e.g., an International Mobile Subscriber Identifier (IMSI)), the data requested (e.g., “Are my friends online?” data request in the SMS message 214), and the data returned (e.g., the generated transaction-specific data in the SMS message 215). The payload may include additional or different information that is not described.

In one implementation, notification messages 228 received at the application server 106 are stored in a receive queue 122 having a first-in-first-out (FIFO) structure. The receive queue 122 passes notification message 228 to the advertisement application 120 for processing in the order it receives them. Upon receipt of a notification message 228, the advertisement application 120 uses application logic resident at the advertisement application 120 to process the information in the payload of the notification message 228 and generate an SMS message 229 to be sent to the user device 102.

Generally, the SMS message 229 generated by the advertisement application 120 has a header and a payload. The header is formatted according to the ETSI GSM 03.48 specification in order to generate in the SIM 110 a reception of a SMS-PP Formatted Envelope event. The header provides a “Toolkit Application Reference” (“TAR”) that uniquely identifies an STK application on the SIM 110. By inserting an identifier associated with an STK application 114 in the TAR header field of the SMS message 229, the user device 102 will pass the received SMS message to the STK application 114 for processing.

The advertisement application 120 uses the payload area of the SMS message 229 to send advertisement content to the user device 102. In one implementation, advertisement content is stored in a database 124 accessible by the advertisement application 120. Each piece of advertisement content is associated with one or more categories (e.g., sports, stocks, weather, and dining) and/or one or more sub-categories (e.g., soccer, baseball, football, tennis, and hockey). When rendered on the screen of the user device 102, the “advertisement content” provides information to a user. The advertisement content can be of a commercial nature, e.g., promotions of products and services, or of a non-commercial nature, e.g., news flashes, tips, and tutorials. If the advertisement content is longer than the maximum payload size of an SMS message, the advertisement application 120 is implemented to send the advertisement content in multiple SMS messages. In one implementation, the advertisement application 120 includes (or has access to) a class library having a number of classes (e.g., a “Display Text” class, and a “Get Info” class) which is used to construct the advertisement content.

The advertisement application 120 uses data provided in the payload of the received notification message 228 to instantiate the “Display Text” class of the library. For example, the advertisement application 120 may also use the IMSI data provided in the payload of the received notification message 228 to retrieve a user profile stored in the database 124 accessible by the advertisement application 120. The user profile information may be provided by a user to the database 124 via a user device 102 or any other user interface device (e.g., a web-based interface) that is in communication with the application server 106, directly or indirectly, through the network 108.

The user profile can include user profile information, such as the user's name, geographic location, interests and hobbies. The user profile information may further include content preference information such as types of audio, video and text information that may be of interest to the user. For example, when establishing a user's profile for audio content, a user may identify not only the type of music that is most enjoyable but the individual artists that the user most or least prefers. Based on this information and other user profile information, the individuals may be associated with certain advertisement content that most closely meets the parameters identified by the user. In another example, the advertisement application 120 may analyze the user's preferences or transaction history and, as a result, infer other preferences of the user. For example, if a user requests baseball score updates for the Boston Red Sox, an inference may be made that the user would like to receive promotional information associated with the Boston Red Sox. An opportunity may be given to the user to confirm or deny these inferences through an item selection process, an example of which is described below.

The advertisement application 120 encodes the “Display Text” advertisement content as a two-dimensional byte array (“advertisement display generation command”) in TLV (Tag-Length-Value) format. Appendix I shows one example of the “Display Text” advertisement display generation command structure. The advertisement application 120 sends an SMS message 229 with the advertisement display generation command as its payload to the user device 102 through the network 108.

Upon receipt of the SMS message 229, the user device 102 examines the TAR header field of the SMS message 229 and directs it to an STK application 114 using an event download 230. The STK application 114 sends a proactive command 231 which causes the user device 102 to display the advertisement content to the user on the screen of the user device 102.

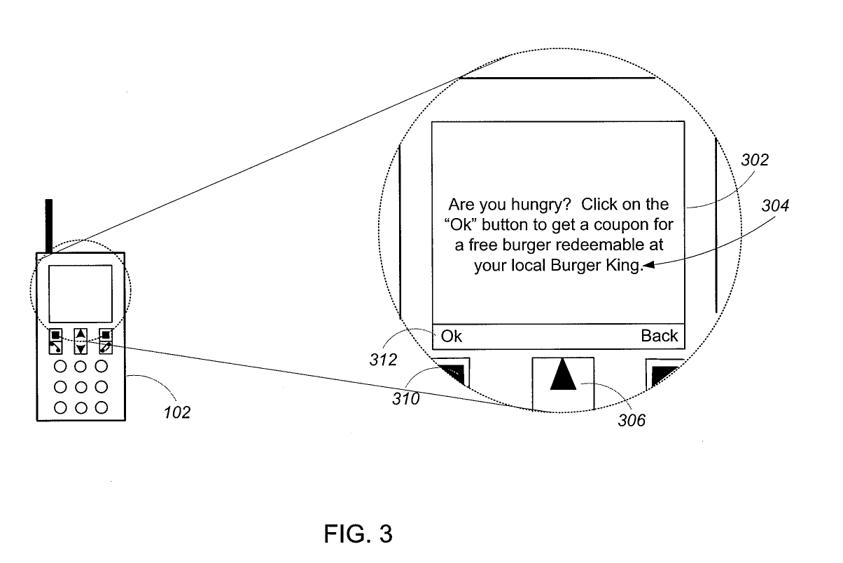

Suppose, for example, that the advertisement content rendered on a screen 302 of the user device 102 provides a message 304 with a promotion offered by a retailer in the area code 617, as shown in FIG. 3. If the user would like to obtain more information about the promotion, the user can click on a button 310 on the user device 102 associated with an “ok” label 312. The user device 102 sends an event download to the STK application 114 which causes the STK application 114 to execute an action (specified in the payload of the SMS message 229 received from the advertisement application 120) associated with the “ok” button 310. Referring to the “Display Text” bytecoded content structure of Appendix I, the “ok” button 310 is associated with an item command encoded in the SMS message 229 from the advertisement application 120. In one implementation, the structure of the “item command” field is “<number><content>”, where “number” refers to a valid MSISN associated with the advertisement application 120 on the application server 106, and “content” refers to a advertisement display request that is to be sent to the advertisement application 120 as payload. In this manner, the “ok” button 310 in different advertisement displays can be associated with different advertisement applications and different payloads. Once the user has clicked on the “ok” button 310, the STK application 114 constructs a SMS message having (as its payload) the advertisement display request associated with the selected item. The STK application 114 passes (via the user device 102) the constructed SMS message to the advertisement application 120 having the number associated with the selected item, where it is processed as described above.

Referring to FIG. 2, in addition to operating in a normal mode, e.g., creating SMS messages having advertisement content in response to the receipt of an SMS message having a MO command by the application server 104, the advertisement application 120 residing on the application server 106 may also operate in a push mode. In such a mode, the advertisement application 120 monitors a data store of events, such as news, weather, stock prices, new services, or other selected information. When the advertisement application 120 detects a change in the data store of events, the advertisement application 120 creates and sends a SMS message 241 to user devices 102 on the network 108 that are associated with the data store in order to provide an updating of the events on the user device 102. This action may occur as a broadcast to all users on the network 108, as a multicast a certain users on the network 108, or as a unicast to a single user based on, e.g., user profile information. Generally, such SMS messages are sent independent of any action taken by a user of the user device 102. This ensures that the data stored or displayed on the user device 102 will be relatively current and correct in relation to the monitored data in the data store. The user device 102 passes such a SMS message 241 to the STK application 114 using an event download 242, which interprets the received advertisement display generation command and instructs the STK framework 112 to execute the appropriate STK proactive command 243.

Other versions of the system 100 can make use of alternatives listed below. The advertisement application 120 may provide a web-based interface through which a mobile network operator or vendor may create, edit, and delete advertisement content. The advertisement application 120 allows a mobile network operator or vendor to associate individual advertisement content with certain parameters (e.g., create a list of Boston-area restaurants that is associated with area code 617). The mobile network operator or vendor may specify to the advertisement application 120 the total number of users on the network 108 that are targeted to receive a SMS message having a particular advertisement content within a given time period. The mobile network operator or vendor may also specify a maximum number of times any given user is to receive SMS messages having advertisement content from the advertisement application 120. If desired, the mobile network operator or vendor may require the advertisement application 120 to keep track of statistics (e.g., the number, type, and/or specific ones of SMS message having advertisement content that have been sent to individual users in addition to the user's responses) that may be used to aid the mobile network operator or vendor in developing a more efficient marketing and promotion strategy.

The server application 118 may be configured to generate a notification message for transmittal to the advertisement application 120 in response to a triggering event other than the receipt of an SMS message from a user device requesting data. For example, a user logs into an account at a web site associated with the mobile network operator by providing a user name and password. The user then navigates to an “info channel” web page that includes information about various value-added subscription services the user may add to his account. In one implementation, the server application 118 is configured to generate a notification message in response to a subscription event at the web site, i.e., a user selecting to add a particular service to his account. The notification message that is generated includes a header that uniquely identifies the advertisement application 120 and a payload that includes information identifying the user (e.g., through account data) and the subscription event (e.g., Boston Red Sox Scores). The advertisement application 120 can use the notification message to generate a SMS message having advertisement content as previously described, and transmit the generated SMS message to a user device 102 associated with the user.

Various alternative versions of the system differ in one or more features. The SIM 110 may have software for a number of text-based, menu-driven, voice recognition SIM applications 112 stored in its memory. The processor may be external to the SIM 110. The SIM 110 may be affixed permanently to the user device 104 (i.e., not removable). The short messages may be encoded using a protocol different from the ETSI TS 123.040 SMS protocol, thus allowing for a different maximum payload size. The communication between the user device 102 and the applications servers (104 and 106) may be accomplished using protocols (e.g., GPRS, CSD) other than the SMS protocol. The server application 122 may include (or have access to) a database of content (e.g., ringtones, logos and games). The server application 122 can interpret an SMS message payload request and execute a “ringtone delivery” action specified by the application business logic. The SIM 110 may support a non-Java-based framework.

The communications system 100 may include a mobile communications network or a satellite communications network. In one example, a server (not shown) may be connected to the mobile communications network via suitable network interface means. The network interface means provide hardware circuitry for enabling the server to communicate with an SMS-C (Short Message Service switching Center) (not shown) of the mobile communications network over a transport protocol such as TCP/IP or X25.

The communications system 100 may use a cellular tower of a mobile network operator to communicate analog or digital signals between two or more remotely located devices. Other versions of the communications system 100 may use any technology, or combination of technologies, for transmitting signals. These technologies include, for example, Advanced Cellular telephone System (AMPS), Narrowband Advanced Cellular telephone Service (NAMPS), Frequency Shift Keying (FSK), Frequency Division Multiple Access (FDMA), Time Division Multiple Access (TDMA), and Code Division Multiple Access (CDMA), or any standard, such as Global System for Mobile communications (GSM) or Cellular Digital Packet Data (CDPD).

A variety of user devices that communicate using the communications system 100, such as a mobile telephone 102, a pager, a personal digital assistants (“PDA”), and a portable personal communicator (such as a mobile communicator), or other two-way messaging devices that are capable of communicating a variety of content including text messages can make use of the approaches described above. The communications system 100 may use a satellite to enable communications between two or more remotely located devices. The satellite may communicate directly with a device, such as a satellite telephone, through a signal, or the satellite may communicate indirectly with a particular mobile communications device, such as the mobile telephone 102, the pager, the PDA, or the portable personal communicator, by communicating signals to a ground station that communicates with the mobile communications devices through another communications network, such as a cellular tower. Some mobile devices, such as the mobile telephone 104 or the PDA, may be able to receive wireless communications from a cellular tower or a satellite.

The communications system 100 may use a communications pathway to connect with the Public Switched Telephone Network (PSTN). The PSTN is a telephone system that is capable of connecting a variety of devices, such as telephones, fax machines, or answering machines (none of which are shown), through a communications system that directs calls to a particular location, generally using land lines.

Each of the application servers 104, 106 may include a communications card or device (e.g., a modem and/or a network adapter) for exchanging data with the network 108 using a communications link (e.g., a telephone line, a wireless network link, a wired network link, or a cable network). Examples of the network 108 include the Internet, the World Wide Web, WANs, LANs, analog or digital wired and wireless telephone networks (e.g., ISDN (“Integrated Services Digital Network”), and DSL (“Digital Subscriber Line”) including various forms of DSL such as SDSL (“Single-line Digital Subscriber Line”), ADSL (“Asymmetric Digital Subscriber Loop), HDSL (“High bit-rate Digital Subscriber Line”), and VDSL (“Very high bit-rate Digital Subscriber Line)), radio, television, cable, satellite, and/ or any other delivery mechanism for carrying data.

Other examples of application servers 104, 106 may include a handheld device, a workstation, a server, a device, a component, other equipment, or some combination of these capable of responding to and executing instructions in a defined manner. Any of the foregoing may be supplemented by, or incorporated in, ASICs (application-specific integrated circuits).

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described herein, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The invention has been described in terms of particular embodiments. Other embodiments are within the scope of the claims. For example, the steps of the invention can be performed in a different order and still achieve desirable results.

What is claimed is:

1. A method comprising:
in a first computing system,
receiving a notification of a triggering event;
generating a short message based on the notification, the generated short message including advertisement content; and
sending the generated short message to a mobile communications device.

2. The method of claim 1, wherein the triggering event comprises an initiation of a short message transaction by the mobile communications device.

3. The method of claim 2, wherein the initiation of the short message transaction comprises the transmission of a short message from the mobile communications device to a second computing system.

4. The method of claim 3, wherein the first computing system and the second computing system are hosted on different servers.

5. The method of claim 2, wherein the short message transaction comprises one or more of
in a second computing system,
receiving a short message from the mobile communications device; and
if the received short message includes a data request,
processing the data request to generate a short message, the generated short message including transaction-specific data, and
sending the generated short message to the mobile communications device.

6. The method of claim 5, further comprising:
in the mobile communications device,
receiving the generated short message from the second computing system;
generating a transaction-specific display based on the received transaction-specific data; and
rendering the transaction-specific display on a screen.

7. The method of claim 5, further comprising:
in the second computing system,
generating a notification upon receipt of the short message from the mobile communications device; and
sending the notification to the first computing system.

8. The method of claim 1, wherein the triggering event comprises a web-based triggering event.

9. The method of claim 8, wherein the web-based triggering event is a subscription event at a web site associated with a second computing system.

10. The method of claim 8, further comprising:
in the second computing system,
generating a notification upon detection of the triggering event; and
sending the notification to the first computing system.

11. The method of claim 1, further comprising:
in the mobile communications device,
receiving the generated short message from the first computing system;
generating an advertisement display based on the received advertisement content; and
rendering the advertisement display on a screen.

12. The method of claim 11, wherein the advertisement display rendered on the screen of the mobile communications device comprises a dynamic menu, a dynamic text display, and a dynamic text display requesting user input.

13. The method of claim 1, wherein the notification includes information characterizing one or more of a user information, a mobile communications device information, a triggering event.

14. The method of claim 13, wherein generating the short message based on the notification comprises:
using the information in the notification to identify one or more categories of advertisement content;
selecting, from among the identified categories, advertisement content; and
encoding the selected advertisement content using one of a plurality of protocols to generate one or more advertisement display generation commands.

15. The method of claim 14, wherein using the information in the notification further comprises:
accessing user profile information associated with the user information included in the notification.

16. The method of claim 14, wherein sending the generated short message to the mobile communications device comprises sending each of the one or more advertisement display generation commands to the mobile communications device separately.

17. A computer program product, tangibly embodied in an information carrier, the computer program product being operable to cause data processing apparatus to:
receive a notification of a triggering event;
generate a short message based on the notification, the generated short message including advertisement content; and
send the generated short message to a mobile communications device.

18. The computer program product of claim 17, wherein the triggering event comprises a short message transaction involving a mobile communications device.

19. The computer program product of claim 17, wherein the notification includes information characterizing one or more of a user information, a mobile communications device information, a triggering event.

20. The computer program product of claim 17, wherein instructions to generate the short message based on the notification comprises instructions to:
use the information in the notification to identify one or more categories of advertisement content;
select, from among the identified categories, advertisement content; and
encode the selected advertisement content using one of a plurality of protocols to generate one or more advertisement display generation commands.

21. The computer program product of claim 20, wherein instructions to use the information in the notification further comprises instructions to:
access user profile information associated with the user information included in the notification.

22. The computer program product of claim 17, wherein instructions to send the generated short message to the mobile communications device comprises instructions to send each of the one or more advertisement display generation commands to the mobile communications device separately.

23. A computer program product, tangibly embodied in an information carrier, the computer program product being operable to cause data processing apparatus to:
receive a short message from a mobile communications device; and
if the received short message includes a data request,
process the data request to generate a short message, the generated short message including transaction-specific data, and
send the generated short message to the mobile communications device.

24. The computer program product of claim 23, further comprising instructions to:
generate a notification upon receipt of the short message from the mobile communications device; and
send the notification to a computing system.

25. A communications system comprising:
a first computing system operative to:
receive a notification of a triggering event;
generate a short message based on the notification, the generated short message including advertisement content; and
send the generated short message to a mobile communications device.

26. The communications system of claim 25, further comprising:
a storage device including advertisement content,
wherein the first computing system is operative to generate the short message based on the notification by:
using the information in the notification to identify one or more categories of advertisement content;
selecting, from among the identified categories, advertisement content;
retrieving, from the storage device, the selected advertisement content and
encoding the selected advertisement content using one of a plurality of protocols to generate one or more advertisement display generation commands.

27. The communications system of claim 25, further comprising:
a second computing system operative to:
receive a short message from a mobile communications device; and
if the received short message includes a data request,
process the data request to generate a short message, the generated short message including transaction-specific data, and
send the generated short message to the mobile communications device.

28. The communications system of claim 27, wherein the receipt of the short message from the mobile communications device is a triggering event, and wherein the second computing system is further operative to:
generate a notification of the triggering event; and
send the notification to the first computing system.

29. The communications system of claim 25, further comprising:
a second computing system operative to:
detect a web-based triggering event;
generate a notification of the web-based triggering event; and
send the notification to the first computing system.

30. An apparatus comprising:
means for receiving a notification of a triggering event;
means for generating a short message based on the notification, the generated short message including advertisement content; and
means for sending the generated short message to a mobile communications device.

31. The apparatus of claim 30, further comprising:
means for detecting a triggering event;
means for generating a notification of the triggering event; and
means for sending the notification to the first computing system.
